(19) United States
(12) Patent Application Publication
(10) Pub. No.: US 2024/0302323 A1
(43) Pub. Date: Sep. 12, 2024

(54) IMAGING OF STAIN-FREE FLUORESCENCE ON WESTERN BLOT MEMBRANES WITH EXCITATION BY EPI ILLUMINATION WITH UV LEDs

(71) Applicant: Bio-Rad Laboratories, Inc., Hercules, CA (US)

(72) Inventors: Kevin McDONALD, Novato, CA (US); Evan THRUSH, San Anselmo, CA (US); Stephen SWIHART, Walnut Creek, CA (US)

(21) Appl. No.: 18/594,870

(22) Filed: Mar. 4, 2024

Related U.S. Application Data
(60) Provisional application No. 63/450,905, filed on Mar. 8, 2023.

(51) Int. Cl. G01N 27/447; H04N 23/56

(52) U.S. Cl. CPC G01N 27/44721; G01N 27/44739; H04N 23/56

(57) ABSTRACT

Systems, methods, and devices for imaging of stain-free fluorescence on western blot membranes with excitation by epi illumination with UV LEDs are disclosed herein. A method can include collecting and preparing a sample, separating the sample via gel electrophoresis in a gel block, transferring the separated sample from the gel block to an analysis block, generating an image of the sample with an imager, and evaluating the image of the sample. The imager can include a plane to receive and hold a block containing a sample and including a first side and a second side, a camera to image a sample on the plane and positioned above the first side of the plane, and an LED light source positioned above the first side of the plane. The LED light source can illuminate the sample on the plane via epi-illumination, and emits light having a wavelength in a range from approximately 325 nm to approximately 400 nm.

### CROSS REFERENCES TO RELATED APPLICATIONS

The present application claims priority to U.S. Provisional Patent Application No. 63/450,905 filed Mar. 8, 2023, the full disclosure of which is incorporated herein by reference in its entirety for all purposes.

### BACKGROUND

Western blot imaging is a widely used analytical technique to detect specific proteins in a sample of tissue homogenate or extract. Western blotting includes three elements, namely, separation of protein by size, transfer of protein to a solid support, and marking the target protein using a primary and secondary antibody to visualize that protein. The primary antibody binds to a target protein, and the secondary antibody binds to the primary antibody. This secondary antibody enables visualization through methods like immunofluorescence, staining, and/or radioactivity to thereby allow indirect detection of the target protein.

While western blot imaging is very effective, western blot imaging has limitations. For example, significant time can be lost in the event of a failed test, as a failed test may not be immediately imageable. Accordingly, further improvements to western blot imaging and imagers used for western blot imaging are desired.

### BRIEF SUMMARY

One aspect of the present disclosure relates to a method of Stain-Free protein imaging. The method includes collecting and preparing a sample comprising proteins, separating the proteins in the sample via gel electrophoresis in a gel block to form separated proteins, the gel block including a compound that bonds with the separated proteins to enhance fluorescence of the separated proteins, transferring the separated proteins from the gel block to an analysis block, generating an image of the analysis block with an imager, and evaluating the image of the analysis block. The imager can include a plane that can receive and hold a block containing separated proteins, the plane having a first side and a second side, a camera that can image a gel block or an analysis block on the plane, the camera positioned above the first side of the plane, and an LED light source positioned above the first side of the plane. In some embodiments, the LED light source can illuminate the sample on the plane via epi-illumination. In some embodiments, the LED light source emits light having a wavelength in a range from approximately 250 nm to approximately 400 nm.

In some embodiments, the gel electrophoresis can be polyacrylamide gel electrophoresis. In some embodiments, the analysis block can be a membrane. In some embodiments, the analysis block can be at least one of a nitrocellulose membrane and a polyvinylidene difluoride (PVDF) membrane. In some embodiments, the LED light source emits light at a wavelength of approximately 325 nm, and in some embodiments, the LED light source emits light at a wavelength of approximately 365 nm.

In some embodiments, the imager further includes a housing having a top and opposing housing first and second sides. In some embodiments, the top extends above and across the plane. In some embodiments, the top connects the housing first side and the housing second side. In some embodiments, each of the opposing housing first and housing second sides extend from adjacent to the plane to an intersection with the top. In some embodiments, the LED light source can be a single LED. In some embodiments, the LED light source can be a plurality of LEDs. In some embodiments, the LED light source can be at least one lensed LED.

In some embodiments, the LED light source can be a first LED positioned on the housing first side between the plane and the intersection of the housing first side with the top, and a second LED positioned on the housing second side between the plane and the intersection of the housing second side with the top. In some embodiments, each of the first LED and the second LED can illuminate the plane. In some embodiments, the LED light source is positioned on the top and can illuminate the plane. In some embodiments, the LED light source includes a first LED and a second LED. In some embodiments, each of the first LED and the second LED are positioned on the top can illuminate the plane.

One aspect of the present disclosure relates to an imaging system. The imaging system includes a plane that can receive and hold a sample, the plane having a first side and a second side. The imaging system can include a camera that can image a sample on the plane. In some embodiments, the camera can be positioned above the first side of the plane. The imaging system can include an LED light source positioned above the first side of the plane. In some embodiments, the LED light source can illuminate the sample on the plane via epi-illumination. In some embodiments, the LED light source emits light having a wavelength in a range from approximately 250 nm to approximately 400 nm.

In some embodiments, the LED light source emits light at a wavelength of approximately one of 325 nm, and 365 nm. In some embodiments, the imager further includes a housing having a top and opposing housing first and housing second sides. In some embodiments, the top extends above and across the plane. In some embodiments, the top connects the housing first side and the housing second side. In some embodiments, each of the opposing housing first and housing second sides extend from adjacent to the plane to an intersection with the top. In some embodiments, the LED light source can be at least one LED. In some embodiments, the LED light source can be at least one lensed LED.

In some embodiments, the LED light source can include a first LED positioned on the housing first side between the plane and the intersection of the housing first side with the top, and a second LED positioned on the housing second side between the plane and the intersection of the housing second side with the top. In some embodiments, each of the first LED and the second LED can illuminate the plane.

In some embodiments, a first centerline of the first LED forms a first angle of between approximately 10 degrees and approximately 25 degrees with the first side of the plane. In some embodiments, a second centerline of the second LED forms a second angle of between approximately 10 degrees and approximately 25 degrees with the first side of the plane. In some embodiments, the LED light source is positioned on the top and can illuminate the plane.

In some embodiments, the LED light source can include a first LED and a second LED. In some embodiments, each of the first LED and the second LED are positioned on the top and can illuminate the plane. In some embodiments, the LED light source is positioned directly above a center point of the plane. In some embodiments, the LED light source is positioned offset from a center point of the plane.

In some embodiments, a centerline of the LED light source is pointed towards a lateral midline of the plane. In some embodiments, a centerline of the LED light source is pointed towards a position offset from a lateral midline of the plane.

### BRIEF DESCRIPTION OF THE DRAWINGS

FIG. 1 is a schematic depiction of one embodiment of a system for imaging of Stain-Free fluorescence on western blot membranes with excitation by epi-illumination.

FIG. 2 is a perspective view of one embodiment of a first side mounted imaging system.

FIG. 3 is a perspective view of one embodiment of a second side mounted imaging system.

FIG. 4 is a side-section view of the imaging system.

FIG. 5 is a side-perspective-section view of one embodiment of a first top-mounted imaging system.

FIG. 6 is a top view of a support plane and portions of a housing adjacent to the support plane of an imaging system.

FIG. 7 is a side-section-perspective view of the imaging system.

FIG. 8 is depiction of embodiments of an LED.

FIG. 9 is a flowchart illustrating one embodiment of a process for imaging of Stain-Free fluorescence on western blot membranes with excitation by epi illumination with UV LEDs.

FIG. 10 is a flowchart illustrating one embodiment of another process for imaging of Stain-Free fluorescence on western blot membranes with excitation by epi illumination with UV LEDs.

FIG. 11 depicts results of imaging generated with epi-illumination.

FIG. 12 depicts results of imaging of binding trihalo compound on the analysis block.

### DETAILED DESCRIPTION

Western blot processing includes, among other things, collecting and preparing a sample, separating the sample via gel electrophoresis in a gel block, transferring the separated sample from the gel block to an analysis block, and generating an image of the sample with an imager. Western blot imaging can reliably image proteins, and thus can detect the presence and/or quantity of one or several target proteins in a sample. From start to finish, western blotting can be time consuming, and errors can only be easily detected late in the imaging process. When an error is detected late in the imaging process, it is possible that the entire time and effort spent performing the blotting process up to the detection of the error is lost. This can result in significant amounts of time and materials being lost.

One challenge in early detection is that many of the blocks used to support the protein sample do not allow transillumination of the protein sample. Specifically, the analysis block is frequently a membrane that does not allow transillumination of the protein sample at the excitation frequencies for the protein. This challenge with transillumination is particularly relevant when the analysis block is a nitrocellulose membrane or a polyvinylidene difluoride (PVDF) membrane. Accordingly, the present disclosure relates to system and methods to enable early detection of errors in the western blot imaging process, and more specifically to enable early imaging of proteins in the gel block or after being transferred to the analysis block.

Further, an improvement on quantifying the relative signal produced by reporter molecules from multiple protein samples on a single analysis block, which can be a membrane is normalization to the total quantity of protein in each protein sample bound to the analysis block. Use of systems and methods as described herein improve this normalization as the use of epi-illumination allows a more accurate determination of the total quantity of protein in each sample bound to the analysis block as compared to the use of trans-illumination.

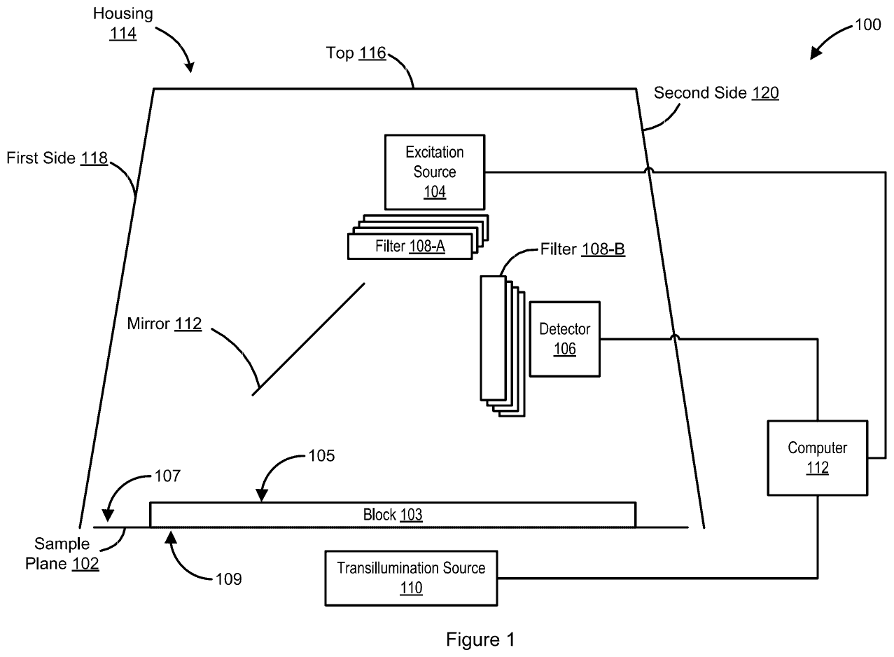

With reference now to FIG. 1, a schematic depiction of one embodiment of a system 100, also referred to herein as an imager 100, for imaging of Stain-Free fluorescence on western blot membranes with excitation by epi-illumination with ultraviolet (“UV”) Light Emitting Diodes (“LEDs”). The system 100 is configured for imaging of western blot membranes, and particularly for imaging of Stain-Free fluorescence on western blot membranes. The system 100 includes a plane 102. The plane 102 can be configured to hold a block 103. The plane 102 can be transparent or can be non-transparent. The plane can comprise a first side 107 and a second side 109. The plane 102 can comprise any desired size and shape, and in some embodiments, can be sized to receive and hold a sample that is on a block 103. In some embodiments, the plane 102 is configured to receive and hold the block 103 on the first side 107 of the plane 102.

The block 103 can include any desired block including, for example, a gel block and/or an analysis block. As used herein, a “gel block” can be a substrate used in separating the proteins as a part of electrophoresis. The substrate can be made of a gel such as, for example, a polyacrylamide gel. In some embodiments, the gel block can be used as part of gel electrophoresis to separate the proteins of the sample. In some embodiments, the gel block can include a trihalo compound that, when bound with a protein, enhances the fluorescence of that protein. Specifically, the bonding of the trihalo compound with the protein shifts the fluorescent emission of the protein to a longer wavelength range that is more readily detectable. The bonding between the trihalo compound and the protein is a covalent bond. In some embodiments, the trihalo compound can be bonded to the protein in the gel block via illumination of the gel block, and specifically via illumination of the gel block with UV light. In some embodiments, this UV light can be generated by a light source, including, for example, the excitation source 104, the transillumination source 110, or any other light source.

As used herein, the “analysis block” can be substrate configured to hold the separated proteins after electrophoresis and during imaging. In some embodiments, the analysis block can be sized and shaped to be received by the sample plate 102 and to be imaged by the system 100. The analysis block can comprise a substrate that can be membrane such as, for example, at least one of: a nitrocellulose membrane; and a polyvinylidene difluoride (PVDF) membrane. In some embodiments, the PVDF membrane can be a low-fluorescence PVDF (“LF PVDF”) membrane. In some embodiments, and as part of western blot imaging, the separated sample can be transferred to the analysis block subsequent to gel electrophoresis and before imaging. In some embodiments, these transferred proteins can already be bound to trihalo compound, and in some embodiments, the transferred proteins can be bound to trihalo compound after being transferred to the analysis block.

The analysis block can immobilize the proteins that are transferred to the analysis block, and thus, the analysis block can be configured to stably hold the separated sample, and not interfere with the imaging of the separated sample. In some embodiments, the proteins of the sample are transferred to one side of the analysis block, and typically to a top 105 of the analysis block. In some embodiments, the top 105 of the analysis block can be the side of the analysis block that is a side of the analysis block that is relatively closes to a detector and/or imager. In some embodiments, the sample can be transferred to the top 105 of the analysis block to improve the ability of the detector and/or image to image light emitted from the sample, as, for example, light passing through the analysis block may be, to some degree, scattered.

The system 100 can further include an excitation source 104. The excitation source can be configured to generate excitation energy, and to direct that excitation energy towards the plane 102. When a block 103 is positioned on the plane 102, and is to be imaged, the excitation source 104 can generate excitation energy that energizes sample on the block 103, and specifically energizes fluorophores coupled to the sample on the block 103, thereby causing the fluorescing of those energized fluorophores. In some embodiments, the excitation source 104 can comprise one or several LEDs, and specifically, one or several UV LEDs. In some embodiments, the LEDs of the excitation source 104 can be lensed, or can be un-lensed. In some embodiments, the excitation source 104 can comprise: a single LED, a plurality of LEDs, at least one lensed LED, and/or at least one un-lensed LED. In some embodiments, the excitation source, and specifically the LEDs of the excitation source can be configured to generate light having a wavelength of between approximately 200 nm and approximately 400 nm, between approximately 325 nm and approximately 400 nm, between approximately 335 nm and approximately 390 nm, more specifically can be between approximately 350 nm and approximately 370 nm, approximately 280 nm, can be approximately 365 nm, or can be any other or intermediate wavelength and/or range of wavelengths. In some embodiments, the LEDs of the excitation source can be configured to generate light having a wavelength that cannot bond sample, and specifically protein in the sample to trihalo compound. In other words, the LEDs of the excitation source can be configured to generate light above the maximum wavelength at which sample can be bonded to the trihalo compound. In some embodiments, this can be, for example, light having a wavelength of at least 325 nm.

The system 100 can include a detector 106. The detector 106 can be configured to detect light emitted and/or reflected by sample on the block 103. In some embodiments, the detector can comprise, for example, an imager, a camera, photodetector such as a photodiode or a phototransistor, or the like. In some embodiments, and as shown in FIG. 1, both the detector 106 and the excitation source 104 are positioned on the same side of the plane, or in other words, and as shown in FIG. 1, are both positioned above the plane 102, and specifically are positioned above the first side of the plane 102. In some embodiments, the excitation source 104 can be configured to illuminate the sample on the plane 102 via epi-illumination.

In some embodiments, the system 100 can include one or several filters 108. These one or several filters 108 can include one or several excitation filters 108-A and/or one or several emission filters 108-B. In some embodiments, the one or several excitation filters 108-A can filter excitation energy, or in other words, can filter energy coming from the excitation source 104. In some embodiments, the one or several emission filters 108-B can filter emission energy, or in other words, can filter energy emitted from the block 103.

The one or several filters 108 can be positioned along the optical path between the plane 102 and one or both of: the excitation source 104; and the detector 106. Thus, in some embodiments, light exits the excitation source 104, passes through one or several filters 108, and impinges on the plane 102 and/or on the block 103 on the plane 102. In some embodiments, light from the plane 102 and/or from the block 103 on the plane 102 passes through the one or several filters 108 and is received by the detector 106. In some embodiments, the filters can comprise any type of filter including, for example, a low-pass filter, a high-pass filter, a notch filter, and/or a bandpass filter. In some embodiments, the filters can be moveable with respect to the one of the excitation source 104 and the detector 106 with which the filter is associated such that a filter 108 can be positioned in the optical path of one or both of the excitation source 104 and the detector 106 to achieve a desired filtering.

In some embodiments, the system 100 can further include a transillumination source 110. The transillumination source 110 can be configured to illuminate the block 103 through the plane 102. In some embodiments, the transillumination source 110 can comprise a source of visible illumination, a source of ultraviolet illumination, a source of infrared illumination, or the source of any other type of electromagnetic energy. The transillumination source 110 on a side of the plane 102 opposite the excitation source 104 and the detector 106, or in other words, the plane 102 can be positioned between the transillumination source 110 and both the excitation source 104 and the detector 106.

The transillumination source 110 can, in some embodiments, be configured to illuminate the gel block to bond the proteins in the gel block to the trihalo compound, thereby “cooking” the gel in the gel block. In some embodiments, the transillumination source 110 can generate light having a different wavelength than the light generated by the excitation source 104. For example, in some embodiments, the transillumination source 110 can generate light having a wavelength less than 325 nm, and in some embodiments, less than 300 nm. In some embodiments, the excitation source 104 can generate light having a wavelength greater than or equal to 325 nm.

In some embodiments, the combination of both the excitation source 104 and the transillumination source 110 in the system 100 can improve system functionality. For example, while the transillumination source 110 can efficiently deliver energy to the gel block to bond sample to the trihalo compound, the transillumination source 110, as discussed above, cannot effectively be used in generating an image of the sample on an analysis block. In contrast to the transillumination source 110, the excitation source 104 cannot efficiently deliver energy to the gel block to bond sample to the trihalo compound. To leverage the relative advantage of each of the excitation source 104 and the transillumination source 110, the excitation source 104 is configured to generate light above a maximum wavelength at which trihalo compound can be bonded to sample. Likewise, and in some embodiments, the transillumination source 110 can be configured to generate light below the maximum wavelength at which trihalo compound can be bonded to sample.

Each of the excitation source, the detector 106, and the transillumination source 110 can be communicatingly coupled to a computer 112. The computer 112 can be configured to control the system 100, and specifically to generate one or several control signals controlling operation of one or several components of the system 100, and to receive information from one or several components of the system 100. Thus, in some embodiments, the computer 112 can receive information from one or several of the excitation source 104, the detector 106, and the transillumination source 110, and can generate and send control signals to one or several of the excitation source 104, the detector 106, and the transillumination source 110.

The computer 112 can, in some embodiments, be configured to provide information to a user and to receive inputs from a user. This can include, for example, providing information to a user via a user interface and/or receiving user inputs via the user interface. In some such embodiments, the computer 112 can include one or several hardware features configured to provide information to the user such as, for example, one or several screens, speakers, displays, or the like. In some embodiment, the computer can include one or several hardware features configured to receive user inputs such as, for example, one or several keyboards, keypads, mouses, microphones, cameras, or the like. In some embodiments, the computer 112 can be hooked to another computing device, and the computer 112 can provide information to this other computing device and can receive user inputs from this other computing device.

The computer 112 can, in some embodiments, comprise one or several computing devices, which can include, for example, one or several personal computers, laptops, computing devices, tablets, smartphones, smart devices, or the like. In some embodiments, the computer can comprise at least a processor and memory. The memory can comprise stored instructions in the form of computer code, that when executed by the processor, cause the computer to take one or several actions. The memory can comprise primary and/or secondary memory. The memory can include, for example, cache memory, RAM, ROM, PROM, EPROM, EEPROM, one or several solid-state drives (SSD), one or several hard drives or hard disk drives, or the like. Thus, in some embodiments, the memory can include volatile and/or non-volatile memory.

The processor can include one or several microprocessors, such as one or several Central Processing Units (CPUs) and/or one or several Graphics Processing Units (GPUs). The processor can be a commercially available microprocessor from Intel®, Advanced Micro Devices, Inc.®, Nvidia Corporation®, or the like.

In some embodiments, the system 100 can include a mirror 112 and/or other reflective surface. The mirror 112 can be positioned in the optical path of the detector 106, and can be positioned to redirect light from the plane 102 to the detector 106 such that the detector 106 does not need to be positioned directly above the plane 102. In some embodiments, the inclusion of the mirror can improve flexibility in locating the detector 106 which can likewise facilitate in the positioning of the excitation source 104.

The system 100 can include housing 114 that can extend wholly or partially around the plane 102. In some embodiments, one or several components of the system 100 can be mounted to the housing 114. In some embodiments, the housing 114, together with the plane 102 can define an internal volume in which one or several components of the system 100 are contained. In some embodiments, for example, the excitation source 104, the detector 106, the filter(s) 108, and/or the mirror 112 can be located in, and/or mounted to the housing 114.

The housing 114 can include a top 116, a housing first side 118, and an opposing housing second side 120. In some embodiments, the top 116 extends above and across the plane 102. The top 116, as shown in FIG. 1, connects the housing first side 118 and the housing second side 120. As further seen in FIG. 1, each of the housing first side 118 and the housing second side 120 extends from a position adjacent to the plane 102 to an intersection with the top 116 of the housing.

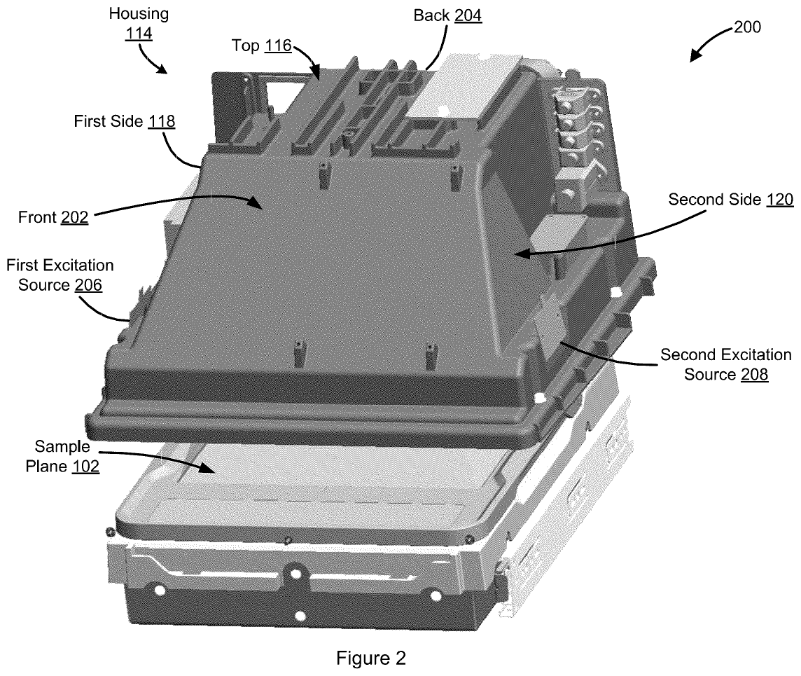

With reference now to FIG. 2, a perspective view of one embodiment of a first side mounted system 200 is shown. The first side mounted system 200 can be a specific configuration of the system 100 shown in FIG. 2, and thus can include some or all of the components and/or features of the system 100. As seen in FIG. 2, the system 200 includes a plane 102 and a housing 114. The housing 114 is positioned above the plane 102, and houses the excitation source 104 and the detector 106. The housing 114 includes the top 116 that connects the opposing housing first side 118 and the housing second side 120. Additionally, the housing 114 includes a front 202 and an opposing back 204. The combination of the top 116, the housing first side 118, the housing second side 120, the front 202, and the back 204 of the housing 114 define an internal volume containing at least the excitation source 104, and the detector 106, and in some embodiments, further containing one or several filters 108. the system is shown.

As further seen in FIG. 2, the excitation source 104 of the system 200 includes a first excitation source 206 coupled to the housing first side 118 of the housing 114 and a second excitation source 208 coupled to the housing second side 120 of the housing 114. In the system 200, the first and second excitation sources 206, 208 are mounted to the housing sides 118, 120 of the housing 114 at a position above the plane 102. Each of the first and second excitation sources 206, 208 is positioned to illuminate all or portions of the plane 102, and specifically to illuminate all or portions of the block 103 on the plane 102. In some embodiments, the first and second excitation sources 206, 208 are positioned so as to illuminate the plane 102, and specifically to uniformly illuminate the plane 102. As will be seen, different embodiments of the system 100 can include different positionings of the excitation source 104 and/or different numbers of sources that together form the excitation source 104.

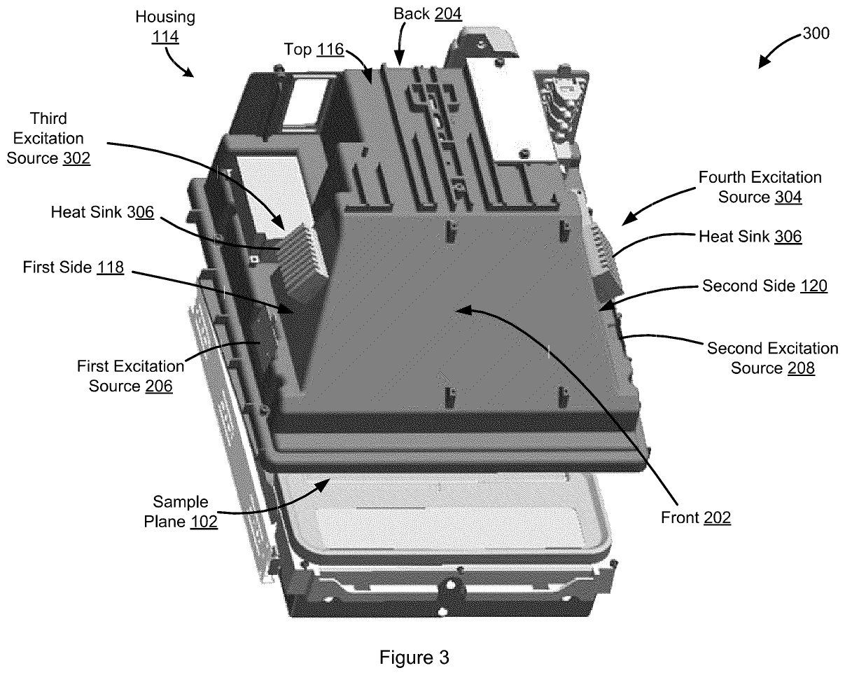

With reference now to FIG. 3, a perspective view of one embodiment of a second side mounted system 300 is shown. The second side mounted system 300 can be a specific configuration of the system 100 shown in FIG. 1, and thus can include some or all of the components and/or features of the system 100. As seen in FIG. 3, the system 300 includes a plane 102 and a housing 114. The housing 114 is positioned above the plane 102, and houses the excitation source 104 and the detector 106. The housing 114 includes the top 116 that connects the opposing housing first side 118 and the housing second side 120, the front 202 and the back 204. The combination of the top 116, the housing first side 118, the housing second side 120, the front 202, and the back 204 of the housing 114 define an internal volume containing at least the excitation source 104, and the detector 106, and in some embodiments, further containing one or several filters 108.

As further seen in FIG. 3, the excitation source 104 of the system 300 includes the first excitation source 206 coupled to the housing first side 118 of the housing 114 and the second excitation source 208 coupled to the housing second side 120 of the housing 114. Both of the first and second excitation sources 206, 208 are coupled to the housing sides 118, 120 of the housing 114 at a first height with respect to the top 116 of the housing 114.

The system 300 further includes a third excitation source 302 coupled to the housing first side 118 of the housing 114 and a fourth excitation source 304 coupled to the housing second side 120 of the housing 114. Both the third and fourth excitation sources 302, 304 are coupled to the housing sides 118, 120 of the housing 114 at a second height with respect to the top 116 of the housing 114. As seen in FIG. 3, the second height with respect to the top 116 of the housing positions the third and fourth excitation sources 302, 304 relatively closer to the top 116 of the housing 114 than the first and second excitation sources 206, 208.

Each of the third and fourth excitation sources 302, 304 is positioned to illuminate all or portions of the plane 102, and specifically to illuminate all or portions of the block 103 on the plane 102. In some embodiments, the third and fourth excitation sources 302, 304 are positioned so as to uniformly illuminate the plane 102. As will be seen, different embodiments of the system 100 can include different positionings of the excitation source 104 and/or different numbers of sources that together form the excitation source 104. In some embodiments, for example, different numbers of sources and/or different positionings of sources forming the excitation source 104 can improve the uniformity of illumination of the plane 102.

As shown, the excitation source 104, and specifically some or all of the first, second, third, and fourth excitation sources 206, 208, 302, 304 can include a heat sink 306. The heat sink 306 can comprise a thermally conductive material and can be configured to cool, either passively or actively, the excitation source to which it is connected. In some embodiments, the heat sink 306 can include one or several features configured to improve the heat dissipation of the heat sink 306. These features can include, for example, one or several features configured to increase the surface area of the heat sink 306 including, for example, one or several ridges, fins, or the like.

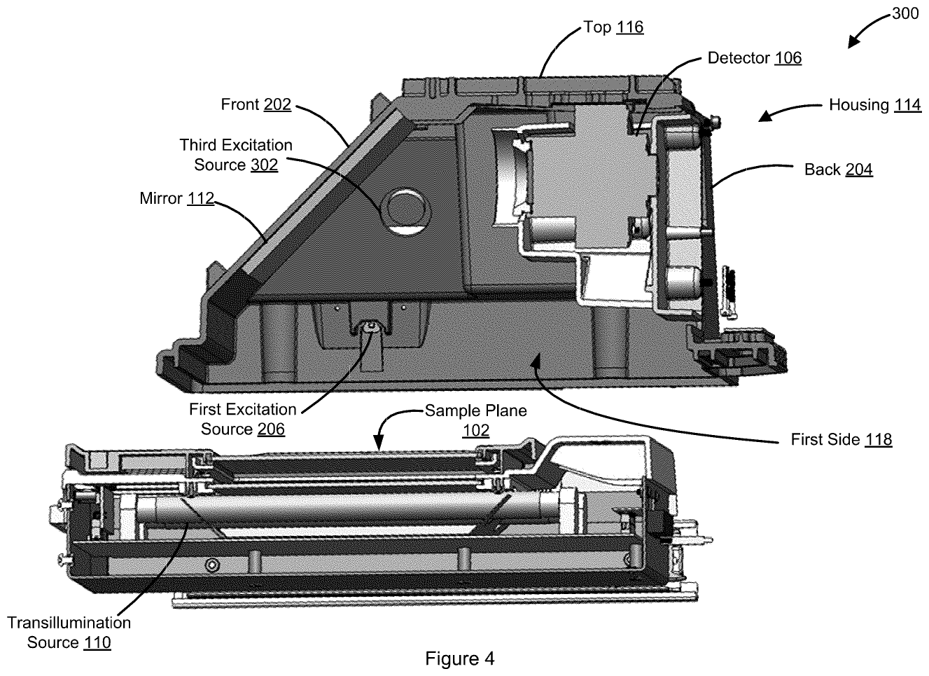

With reference now to FIG. 4, a side-section view of the system 300 is shown. As seen, the system 300 the excitations sources 206, 302 extend through the first side and into an interior volume defined by the housing 114. These excitation sources 206, 302 can each comprise one or several LEDs, and can be positioned and oriented to illuminate the plane 102.

The system 300 further includes a detector 106 which is coupled to the back 204 of the housing 114. The detector 106 can be configured to image a sample on the plane 102, and can be positioned above the plane 102, and specifically can be positioned above the first side 107 of the plane 102. The detector 106 can comprise a camera, which can be a cooled camera or an uncooled camera.

The detector 106 can have the mirror 112 in its optical path to the plane 102. The mirror 112 can be affixed to a portion of the housing 114, and specifically to the front 202 of the housing 114. The mirror can be positioned such that light from the sample plate is reflected by the mirror 114 to the detector 106.

The system 300 can further include the transillumination source 110. The transillumination source 110, as depicted in FIG. 4, can be positioned below the plane 102. The transillumination source 110 can comprise one or several light emitting features such as one or several lightbulbs, LEDs, or the like. In some embodiments, the transillumination source 110 can be configured to emit UV, blue, and/or amber light. In some embodiments, the transillumination source 110 can emit electromagnetic radiation having a wavelength of between approximately 250 nm and approximately 350 nm, between approximately 250 nm and approximately 325 nm, and specifically between approximately 256 nm and approximately 320 nm.

In some embodiments, the transilluminator can be used for imaging of a gel block, or any other block 103 imageable via transillumination or to cause the covalent bonding of the trihalo compound with protein sample in the gel block to enhance fluorescence. In some embodiments, for example, a gel block can have sufficient clarity as to allow illumination via transillumination. In some embodiment, the transilluminator can be any source of electromagnetic radiation configured to irradiate gel forming the gel block.

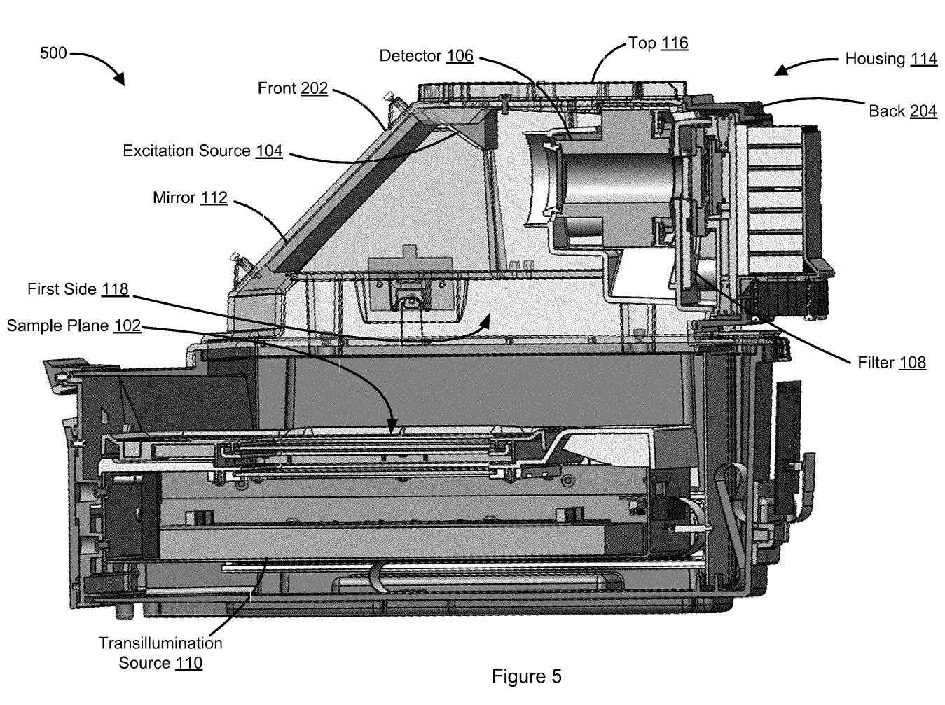

With reference to FIG. 5, a side-perspective-section view of one embodiment of a first top-mounted system 500 is shown. The top mounted system 500 can be a specific configuration of the system 100 shown in FIG. 1, and thus can include some or all of the components and/or features of the system 100. As seen in FIG. 5, the system 500 includes a plane 102 and a housing 114. The housing 114 is positioned above the plane 102, and houses the excitation source 104 and the detector 106. As seen in FIG. 5, the detector 106 includes a filter 108, which can comprise, for example, a filter wheel.

The housing 114 includes the top 116 that connects the opposing housing first side 118 and the housing second side 120, the front 202 and the back 204. The combination of the top 116, the housing first side 118, the housing second side 120, the front 202, and the back 204 of the housing 114 define an internal volume containing at least the excitation source 104, and the detector 106, and in some embodiments, further containing one or several filters 108.

As further seen in FIG. 5, the excitation source 104 of the system 500 is coupled to the top 116 of the housing 114, adjacent to the mirror 112. In some embodiments, the excitation source comprises one LED, and in some embodiments, the excitation source 104 comprises a plurality of LEDs. Specifically, in some embodiments, the excitation source 104 comprises a first LED and a second LED, both of which LEDs are positioned on the top 116, or in other words, coupled to the top 116 of the housing 114, and are configured to illuminate the plane 102.

In some embodiments, the excitation source 104 is positioned and oriented with respect to the plane 102 so that the excitation source 104 illuminates all or portions of the plane 102, and in some embodiments, uniformly illuminates the plane 102. In some embodiments, the excitation source 104, which can be an LED light source, can be positioned directly above a center point of the plane 102, and in some embodiments, the excitation source 104 can be positioned offset from the center point of the plane 102. In some embodiments, the excitation source 104 can be oriented such that a centerline of the excitation source 104, and more specifically of the light emitted by the excitation source 104 is pointed at, or in other words, towards, a lateral midline of the plane 102. In some embodiments, the excitation source 104 can be oriented such that a centerline of the excitation source 104, and more specifically of the light emitted by the excitation source 104 is pointed at, or in other words, towards, a position offset from the lateral midline of the plane 102.

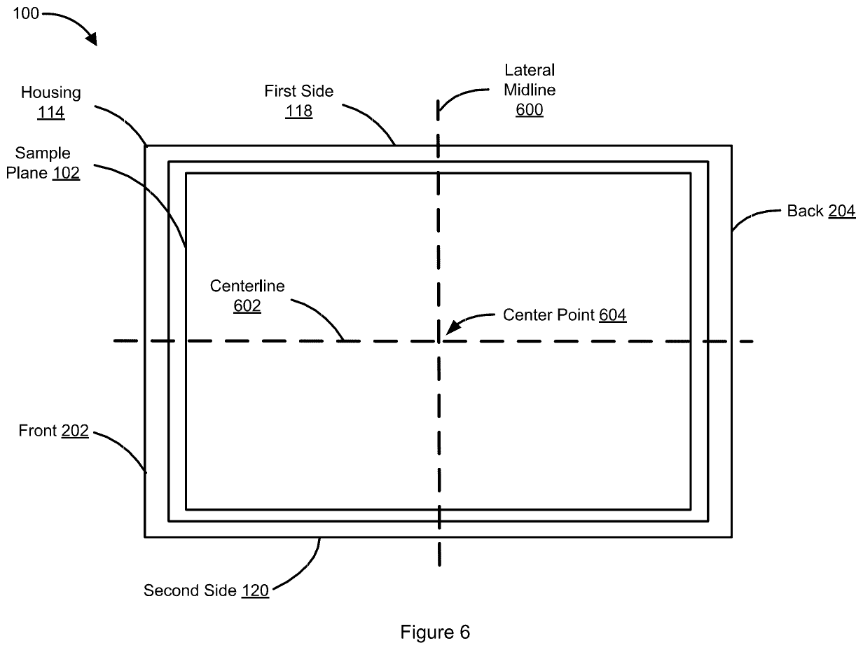

The lateral midline 600, the centerline 602, and the center point 604 are depicted in FIG. 6, which shows a top view of a support plane 102 and portions of the housing 114 adjacent to the support plane. As seen in FIG. 6, the lateral midline 600 extends across the support plane 102 in the direction of the shortest distance between the housing first side 118 and the housing second side 120 at the midline of the support plane 102 and through the centroid of the support plane 102. The centerline 602 extends across the support plane 102 in the direction of the shortest distance between the front 200 and the back 202 at the midline of the support plane 102 and through the centroid of the support plane 102. The center point 604 is located at the centroid of the support plane, which is also the point of intersection between the centerline 602 and the lateral midline 600.

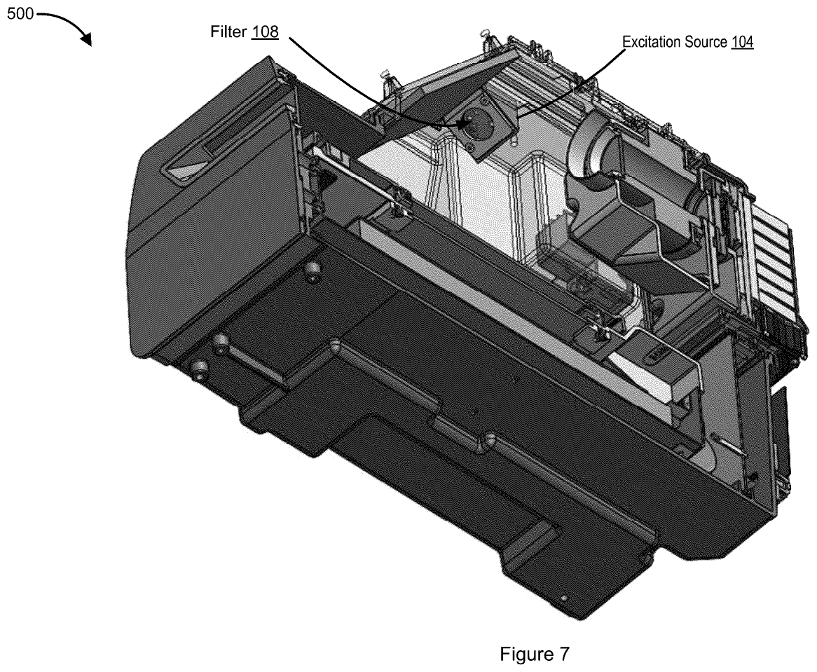

With reference now to FIG. 7, a side-section-perspective view of the system 500 is shown. As seen, the excitation source 104 is coupled to a filter 108. The filter 108 can comprise a static filter, or an adjustable filter. In some embodiments, the filter 108 can be adjusted via a mechanical operation such as with a filter wheel.

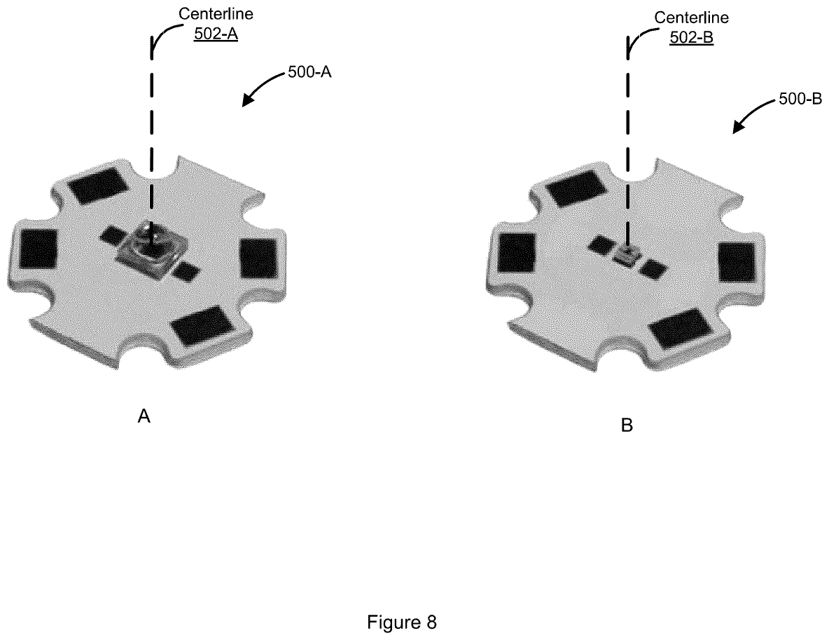

With reference now to FIG. 8 embodiment of an LED 500 that can be part of an excitation source 104 are shown. FIG. 8 depicts two LEDs 500, a first, lensed LED 500-A, and a second, un-lensed LED 500-B. Each of the LEDs include a centerline 502. The centerline 502 of the LEDs 500 extends from the LED 500 along the middle of the light emitted by the LED 500. In embodiments in which the intensity of the light emitted by the LED 500 varies, the centerline 502 of the LED can be along a line of highest intensity of emitted light.

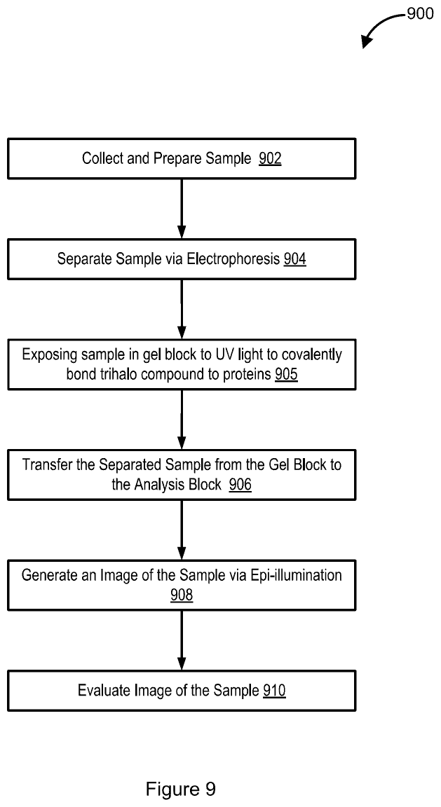

With reference now to FIG. 9, a flowchart illustrating one embodiment of a process 900 for imaging of Stain-Free fluorescence on western blot membranes with excitation by epi illumination with UV LEDs is shown. The process 900 can be performed by the system 100 including, for example, systems 300, 500. The process 900 begins at block 902, wherein a sample is collected and prepared. In some embodiments, the sample can include one or several proteins. Thus, in some embodiments, the sample includes at least one protein.

At step 904, the sample, and specifically the protein in the sample, is separated via electrophoresis. This can include loading the sample on a block, and specifically on a gel block. The proteins in the sample can then be separated via gel electrophoresis. In some embodiments, the gel can be a polyacrylamide gel, and the gel electrophoresis can comprise polyacrylamide gel electrophoresis.

In some embodiments, the gel block can include a trihalo compound that can bind with proteins in the sample. As indicated in step 905, the sample in the gel block can be bound to the trihalo compound. In some embodiments, this can include exposing the gel block to UV light to covalently bond protein on the block to the trihalo compound, thereby enhancing the fluorescence of the protein. In some embodiments, this UV light can be generated by a light source, including, for example, the excitation source 104, the transillumination source 110, or any other light source. Thus, in some embodiments, step 905 includes transilluminating the gel block with an ultraviolet (UV) light to bond the separated proteins to the compound to enhance fluorescence of the separated proteins.

Due to the fluorescing compound in the block, a separate step to stain the proteins is not required as part of process 900. In some embodiments, and as part of the separation via electrophoresis, proteins in the gel block can be imaged to confirm separation of the proteins.

At block 906, the separated sample is transferred, and specifically the separated proteins are transferred from the gel block to the analysis block. The analysis block, as discussed above, can be a nitrocellulose membrane, or a PVDF membrane, including a LF PVDF membrane. In some embodiments, the transfer can be performed using, for example, electroblotting, wherein an electric current pulls proteins from the gel block towards the analysis block. In some embodiments, this can include providing the analysis block with a positive charge, and providing the proteins with a negative charge such that the difference in charge between the proteins and the analysis block pulls the proteins to the analysis block.

At block 908, an image of the sample block, and specifically of the sample on the analysis block is generated via epi-illumination. In some embodiments, the image of the sample block can be generated utilizing the system 100 including, for example, systems 300, 500. This imager can include, for example, the plane 102 configured to receive and hold a block 103 containing the sample, a detector 106, which can be a camera, configured to image the sample on the plane 102, and specifically to image the gel block on the plane 102, and the excitation source 104, which can be an LED light source. Both the excitation source 104 and the detector 106 can be positioned on the same side of the plane 102, and specifically can both be positioned above the plane 102. In some embodiments, the excitation source 104 can emit light having a wavelength in a range of approximately 275 nm to approximately 370 nm.

In some embodiments, the excitation source 104 can be positioned on the top 116 of the housing 114 and can be configured to illuminate the plane 102. In some embodiments, for example, the excitation source 104 can include a first LED and a second LED. In such an embodiment, each of the first LED and the second LED can be positioned on the top 116 of the housing and are configured to illuminate the plane 102. Alternatively, in some embodiments, the excitation source 104 can include a first LED positioned on the housing first side 118 between the plane 102 and the intersection of the housing first side 118 with the top 116, and a second LED positioned on the housing second side 120 between the plane 102 and the intersection of the housing second side 120 with the top 116. In some embodiments, each of the first LED and the second LED are positioned and oriented to illuminate the plane 102. In some embodiments, a first centerline 502 of the first LED forms a first angle of between approximately 10 degrees and approximately 25 degrees with of the first side 105 of the plane 102, and the second centerline 502 of the second LED forms a second angle of between approximately 10 degrees and approximately 25 degrees with the first side 105 of the plane 102. In some embodiments, the first angle is equal to the second angle, and in some embodiments, the first angle is different than the second angle.

In some embodiments, the imaging of the sample can be controlled by the computer 112. Specifically, the computer can generate control signals controlling the excitation source 104 and, in some embodiments, controlling both the excitation source 104 and the filter 108 to deliver excitation energy having a desired wavelength to the sample on the plane 102, and specifically to the gel block on the plane 102. The computer 112 can also generate one or several control signals controlling the operation of the detector 106, and in some embodiments, controlling operation of the detector 106 and the filter 108 to generate an image of light from the sample and having a desired wavelength and/or having a wavelength falling in a range of desired wavelengths.

In some embodiments, the imaging of the sample can be performed as a part of quantifying the total amount of protein in the sample. This can include determining the total amount of protein in the sample based on the total fluorescence of the sample in response to excitation via the excitation source. Once the total amount of protein in the sample is determined, the quantity of each target protein in the sample can be normalized based on the total amount of protein in the sample.

At step 910, the image of the sample can be evaluated or stored. In some embodiments, the image of the sample can be evaluated by the computer 112. In some embodiments, evaluating the image can include displaying the image to a user via a user interface or providing information to another computing device that displays the image to the user via a user interface. In some embodiments, the evaluation of the image can include the quantifying of the total protein in the sample, and the normalization to the total quantity of protein in the sample. In some embodiments, the step of block 910 can include storing the generated image to memory, which can include, for example, memory of the computer 112, or memory of another computing device.

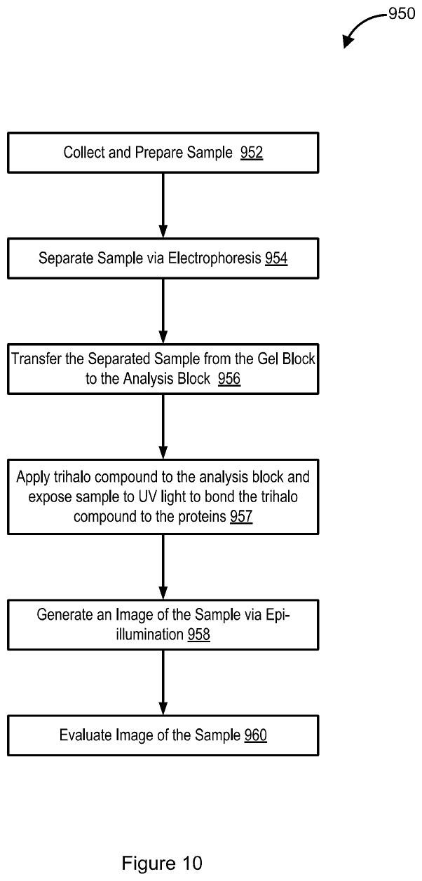

With reference now to FIG. 10, a flowchart illustrating one embodiment of a process 950 for imaging of Stain-Free fluorescence on western blot membranes with excitation by epi illumination with UV LEDs is shown. The process 950 is similar to the process 900, but with the difference that protein can be bound to a trihalo compound on the analysis block as opposed to on the gel block. The process 950 can be performed by the system 100 including, for example, systems 300, 500. The process 950 begins at block 952, wherein a sample comprising proteins is collected and prepared. In some embodiments, the sample can include one or several proteins. Thus, in some embodiments, the sample includes at least one protein.

At step 954, the sample is separated, and specifically the proteins in the sample are separated via electrophoresis. This can include loading the sample on a block, and specifically on a gel block. The proteins in the sample can then be separated via gel electrophoresis. In some embodiments, the gel can be a polyacrylamide gel, and the gel electrophoresis can comprise polyacrylamide gel electrophoresis.

At step 956, the separated sample is, and specifically the separated proteins are transferred from the gel block to the analysis block. The analysis block, as discussed above, can be a nitrocellulose membrane, or a PVDF membrane, including a LF PVDF membrane. In some embodiments, the transfer can be performed using, for example, electroblotting, wherein an electric current pulls proteins from the gel block towards the analysis block. In some embodiments, this can include providing the analysis block with a positive charge, and providing the proteins with a negative charge such that the difference in charge between the proteins and the analysis block pulls the proteins to the analysis block.

At step 957, the protein on the analysis block can be bound to trihalo compound to enhance the fluorescence of the protein. In some embodiments, this can include applying trihalo compound to the analysis block. In some embodiments, the trihalo compound can be in liquid form or in a liquid that can be applied to the analysis block. In some embodiments, for example, the trihalo compound can be poured onto the analysis block and/or can be sprayed on the analysis block. In some embodiments, the analysis block can be wholly or partially dipped into trihalo compound. Binding the protein on the analysis block to the trihalo compound can further include exposing the analysis block to UV light to covalently bond protein, and specifically to covalently bond separated protein on the block, to the trihalo compound, thereby enhancing the fluorescence of the protein. In some embodiments, this UV light can be generated by a light source, including, for example, the excitation source 104, the transillumination source 110, or any other light source.

At block 958, an image of the analysis block, and specifically of the sample on the analysis block is generated via epi-illumination. In some embodiments, the image of the sample block can be generated utilizing the system 100 including, for example, systems 300, 500. This imager can include, for example, the plane 102 configured to receive and hold a block 103 containing the sample, a detector 106, which can be a camera, configured to image the sample on the plane 102, and the excitation source 104, which can be an LED light source. Both the excitation source 104 and the detector 106 can be positioned on the same side of the plane 102, and specifically can both be positioned above the plane 102. In some embodiments, the excitation source 104 can emit light having a wavelength in a range of approximately 275 nm to approximately 370 nm.

In some embodiments, the excitation source 104 can be positioned on the top 116 of the housing 114 and can be configured to illuminate the plane 102. In some embodiments, for example, the excitation source 104 can include a first LED and a second LED. In such an embodiment, each of the first LED and the second LED can be positioned on the top 116 of the housing and are configured to illuminate the plane 102. Alternatively, in some embodiments, the excitation source 104 can include a first LED positioned on the housing first side 118 between the plane 102 and the intersection of the housing first side 118 with the top 116, and a second LED positioned on the housing second side 120 between the plane 102 and the intersection of the housing second side 120 with the top 116. In some embodiments, each of the first LED and the second LED are positioned and oriented to illuminate the plane 102. In some embodiments, a first centerline 502 of the first LED forms a first angle of between approximately 10 degrees and approximately 25 degrees with of the first side 105 of the plane 102, and the second centerline 502 of the second LED forms a second angle of between approximately 10 degrees and approximately 25 degrees with the first side 105 of the plane 102. In some embodiments, the first angle is equal to the second angle, and in some embodiments, the first angle is different than the second angle.

In some embodiments, the imaging of the sample can be controlled by the computer 112. Specifically, the computer can generate control signals controlling the excitation source 104 and, in some embodiments, controlling both the excitation source 104 and the filter 108 to deliver excitation energy having a desired wavelength to the sample on the plane 102. The computer 112 can also generate one or several control signals controlling the operation of the detector 106, and in some embodiments, controlling operation of the detector 106 and the filter 108 to generate an image of light from the sample and having a desired wavelength and/or having a wavelength falling in a range of desired wavelengths.

In some embodiments, the imaging of the sample can be performed as a part of quantifying the total amount of protein in the sample. This can include determining the total amount of protein in the sample based on the total fluorescence of the sample in response to excitation via the excitation source. Once the total amount of protein in the sample is determined, the quantity of each target protein in the sample can be normalized based on the total amount of protein in the sample.

At step 960, the image of the sample can be evaluated or stored. In some embodiments, the image of the sample can be evaluated by the computer 112. In some embodiments, evaluating the image can include displaying the image to a user via a user interface or providing information to another computing device that displays the image to the user via a user interface. In some embodiments, the evaluation of the image can include the quantifying of the total protein in the sample, and the normalization to the total quantity of protein in the sample. In some embodiments, the step of block 960 can include storing the generated image to memory, which can include, for example, memory of the computer 112, or memory of another computing device.

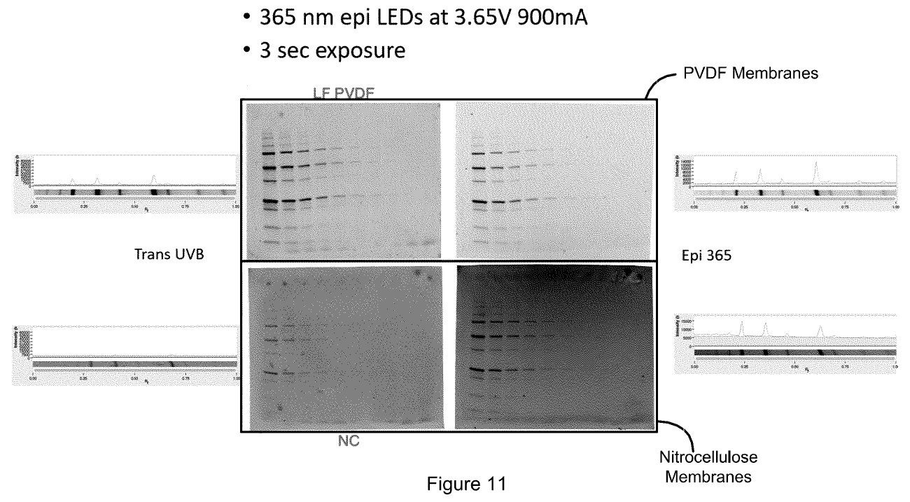

With reference to FIG. 11, results of imaging generated with epi-illumination as described herein are compared to results with transillumination. Specifically, FIG. 11 includes results for two different membranes, namely, a LF PVDF membrane and a nitrocellulose membrane. Each of these was exposed, first to transillumination (left-hand column), and then to epi-illumination (right-hand column) with UV light at 365 nm. As seen, epi-illumination results in significantly improved detection and imaging. This is seen via direct comparison of the shown captured images, but even more clearly in the adjacent graphs.

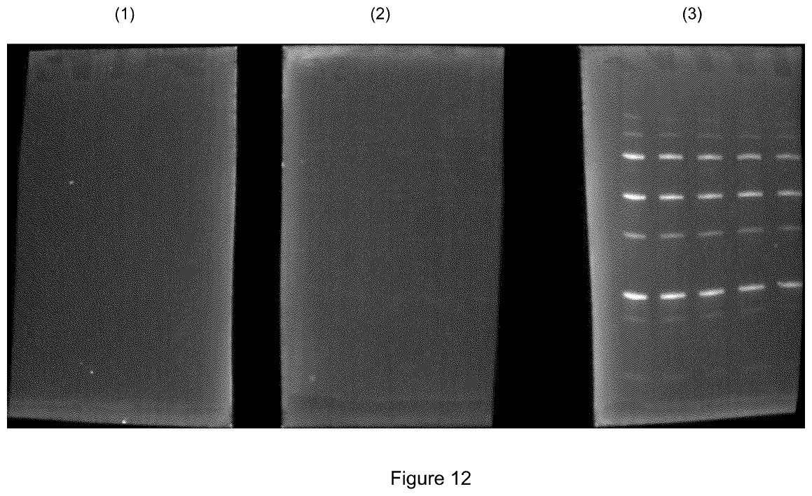

With reference to FIG. 12, results of binding trihalo compound on the analysis block are shown. As seen, FIG. 12 depicts three images of imaged PVDF membrane containing protein samples. These images were generated by applying protein standards to three gel blocks. Two of these gel blocks did not include trihalo compound, and the third gel block included trihalo compound. The protein was separated on the gel blocks, and the protein bands were then transferred to PVDF membranes.

Each of the membranes was placed in Tris-Glycine-Sodium Dodecyl Sulfate (“TGS”) buffer. The buffer in which one of these membranes was laid further included trihalo compound in the form of 1% Trichloroethanol (“TCE”).

Each of the membranes was then placed in an imager and was exposed to UV light to allow the proteins in the sample to react with and bind to any present trihalo compound. This binding was done with 280 nm light.

During this binding reaction, each of the membranes was periodically imaged. Specifically, images were collected for one second, and a three second gap was left between subsequent captured images.

Some of the collected images are shown in FIG. 12. Specifically, image (1) corresponds to sample that was separated on a non-stain-free gel block and the membrane to which protein bands were transferred was not soaked in TCE. Image (2) corresponds to sample that was separated on a stain-free gel block and the membrane to which protein bands were transferred was not soaked in TCE. Image (3) corresponds to sample that was separated on a non-stain-free gel block and the membrane to which protein bands were transferred was soaked in TCE. Each of images (1), (2), and (3) were collected after the same amount of exposure to 280 nm light.

As seen in FIG. 12, the membrane soaked in TCE provides the most rapid rise in signal during the binding reaction. Thus, as compared to the other samples, the membrane soaked in TCE can be successfully imaged quicker than either the membrane in image (1) or the membrane in image (2).

This description should not be interpreted as implying any particular order or arrangement among or between various steps or elements except when the order of individual steps or arrangement of elements is explicitly described. Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

1. A method of Stain-Free protein imaging, the method comprising:
collecting and preparing a sample comprising proteins;
separating the proteins in the sample via gel electrophoresis in a gel block to form separated proteins, the gel block comprising a compound that bonds with the proteins to enhance fluorescence of the separated proteins;
transilluminating the gel block with an ultraviolet (UV) light to bond the separated proteins to the compound to enhance fluorescence of the separated proteins;
transferring the separated proteins from the gel block to an analysis block;
generating an image of the analysis block with an imager, the imager comprising:
a plane configured to receive and hold the analysis block containing separated proteins, the plane having a first side and a second side;
a transillumination source;
a camera configured to image the gel block on the plane, the camera positioned above the first side of the plane; and
an LED light source positioned above the first side of the plane, the LED light source configured to illuminate the gel block on the plane via epi-illumination, wherein the LED light source emits light having a wavelength in a range from approximately 325 nm to approximately 400 nm; and
evaluating the image of the gel block.

2. The method of claim 1, wherein the gel electrophoresis comprises polyacrylamide gel electrophoresis.

3. (canceled)

4. The method of claim 1, wherein the analysis block comprises at least one of: a membrane; a nitrocellulose membrane; and a polyvinylidene difluoride (PVDF) membrane.

5. The method of claim 1, wherein the compound that bonds with the separated proteins to enhance fluorescence of the separated proteins comprises a trihalo compound, wherein the LED light source emits light at a wavelength that cannot bond sample to the trihalo compound.

6. The method of claim 1, wherein the LED light source emits light at a wavelength of approximately 365 nm.

7. The method of claim 1, wherein the imager further comprises a housing having a top and opposing housing first and housing second sides, wherein the top extends above and across the plane, wherein the top connects the housing first side and the housing second side, and wherein each of the opposing housing first and housing second sides extend from adjacent to the plane to an intersection with the top.

8. The method of claim 7, wherein the LED light source comprises at least one of: a single LED; a plurality of LEDs; or at least one lensed LED.

9. (canceled)

10. (canceled)

11. The method of claim 7, wherein the LED light source comprises a first LED positioned on the housing first side between the plane and the intersection of the housing first side with the top; and a second LED positioned on the housing second side between the plane and the intersection of the housing second side with the top, wherein each of the first LED and the second LED are configured to illuminate the plane.

12. The method of claim 7, wherein the LED light source is positioned on the top and is configured to illuminate the plane.

13. The method of claim 12, wherein the LED light source comprises a first LED and a second LED, wherein each of the first LED and the second LED are positioned on the top and are configured to illuminate the plane.

14. An imaging system comprising:
a plane configured to receive and hold a block, the plane having a first side and a second side;
a camera configured to image a block on the plane, the camera positioned above the first side of the plane;
a transillumination source positioned below the second side of the plane; and
an LED light source positioned above the first side of the plane, the LED light source configured to illuminate the block on the plane via epi-illumination, wherein the LED light source emits light having a wavelength in a range from approximately 325 nm to approximately 400 nm.

15. The imaging system of claim 14, wherein the LED light source emits light at a wavelength of approximately 365 nm.

16. The imaging system of claim 14, wherein the imager further comprises a housing having a top and opposing housing first and housing second sides, wherein the top extends above and across the plane, wherein the top connects the housing first side and the housing second side, and wherein each of the opposing housing first and housing second sides extend from adjacent to the plane to an intersection with the top.

17. The imaging system of claim 16, wherein the LED light source comprises at least one of:
at least one LED; or
at least one lensed LED.

18. (canceled)

19. The imaging system of claim 16, wherein the LED light source comprises a first LED positioned on the housing first side between the plane and the intersection of the housing first side with the top; and a second LED positioned on the housing second side between the plane and the intersection of the housing second side with the top, wherein each of the first LED and the second LED are configured to illuminate the plane.

20. The imaging system of claim 19, wherein a first centerline of the first LED forms a first angle of between approximately 10 degrees and approximately 25 degrees with the first side of the plane, and wherein a second centerline of the second LED forms a second angle of between approximately 10 degrees and approximately 25 degrees with the first side of the plane.

21. The imaging system of claim 16, wherein the LED light source is positioned on the top and is configured to illuminate the plane.

22. The imaging system of claim 21, wherein the LED light source comprises a first LED and a second LED, wherein each of the first LED and the second LED are positioned on the top and are configured to illuminate the plane.

23. The imaging system of claim 21, wherein the LED light source is positioned directly above a center point of the plane.

24. The imaging system of claim 21, wherein the LED light source is positioned offset from a center point of the plane.

25. The imaging system of claim 24, wherein at least one of:
a centerline of the LED light source is pointed towards a lateral midline of the plane; or
a centerline of the LED light source is pointed towards a position offset from a lateral midline of the plane.

26-39. (canceled)
